(19) United States
(12) Patent Application Publication
(10) Pub. No.: US 2022/0127696 A1
(43) Pub. Date: Apr. 28, 2022

(54) PROCESS AND SYSTEM FOR EXTRACTION OF RARE EARTH ELEMENTS USING AN ACID SOAK

(71) Applicant: HER MAJESTY THE QUEEN IN RIGHT OF CANADA AS REPRESENTED BY THE MINISTER OF NATURAL RESOURCES CANADA, Ottawa (CA)

(72) Inventors: Chen XIA, Kanata (CA); Wesley GRIFFITH, Ottawa (CA); John DUTRIZAC, Ottawa (CA)

(21) Appl. No.: 17/425,917

(22) PCT Filed: May 6, 2020
(86) PCT No.: PCT/CA2020/050615

§ 371 Date: Jul. 26, 2021

Related U.S. Application Data
(60) Provisional application No. 62/943,850, filed on Dec. 5, 2019.
(60) Provisional application No. 62/843,869, filed on May 6, 2019.

(51) Int. Cl. C22B 3/08; C22B 59/00; C22B 1/00

(52) U.S. Cl. CPC C22B 3/08; C22B 1/00; C22B 59/00

(57) ABSTRACT

The present application provides a process and system for extraction of rare earth elements using a long-term acid soak. In particular the present application provides a process for extracting rare earth elements from an ore by: (a) soaking the ore with a strong acid at a temperature of less than about 100° C. for at least 1 day; and (b) leaching the acid-soaked ore with an aqueous leaching solution to obtain a leachate comprising the rare earth elements. Optionally, a small amount of water is added to the acid during the acid soaking step and/or an additive comprising one or more metal ions is added to the acid during the acid soaking step.

### CROSS-REFERENCE TO RELATED APPLICATIONS

The present application claims priority from U.S. Provisional Patent Application No. 62/843,869, filed May 6, 2019, and U.S. Provisional Patent Application No. 62/943,850, filed Dec. 5, 2019, which are incorporated herein in their entirety.

### FIELD OF THE INVENTION

The present application pertains to the field of rare earth recovery. More particularly, the present application relates to a method and system for recovery of rare earth elements using an acid soak.

### INTRODUCTION

Rare earth elements (REE) are a group of 17 elements that play an important role in modern society, with many high-tech and clean energy applications, such as in permanent magnets for wind turbines, smart phone components, and rechargeable batteries for electric vehicles (Sadri, Nazari, & Ghahreman, 2017). The group of 17 elements comprises scandium and yttrium in addition to the 15 lanthanides (lanthanum to lutetium).

There are two main components to the rare earth (RE) production industry: the extraction of REE from ore, and the separation of REE mixtures into individual compounds. On the extraction side, the two main commercial methods involve either acid baking or caustic conversion (Demol & Senanayake, 2018). Since REE generally occur together in minerals, the extraction step yields a mixture of rare earths, and purifying these into individual element compounds is a complicated and costly operation, due to the similarity in their chemical properties.

Today, industry uses a multi-step extraction process that follows the general formula: decompose→leach→remove impurities→convert to useful or marketable products, such as rare earth chlorides or rare earth oxides. FIG. 1 illustrates a typical extraction process using acid baking.

Decomposition of the rare earth ore can be achieved using various methods that fall under the two categories mentioned previously (i.e., acid baking or caustic conversion). One such method uses a combination of sulfuric acid baking and water leaching. Sulfuric acid baking is employed commercially by the world's largest producer of rare earths at Bayan Obo in China, where they process mixed bastnaesite/monazite concentrate (Demol & Senanayake, 2018). During baking, the acid reacts with the ore to produce rare earth sulfates, as shown in the equations below for bastnaesite (Eq. 1) and monazite (Eq. 2), the two minerals in which the majority of the world's rare earths are found (Qi, 2018, pp. 22, 56).

2REFCO₃+3H₂SO₄→RE₂(SO₄)₃+2HF↑+2CO₂↑+2H₂O ↑ (1)

2REPO₄+3H₂SO₄→RE₂(SO₄)₃+2H₃PO₄ (2)

In addition, impurities such as thorium, calcium and iron are also converted to their sulfates. Once decomposition by acid baking is complete, the sulfates are dissolved into the leachate and the remaining solid, which contains silica, zircon, and other undigested ore residues, is filtered off. The water leaching reaction of interest is shown in Eq. 3 (Sadri, Nazari, & Ghahreman, 2017).

RE₂(SO₄)₃.nH₂O₍ₛ₎→2REE_{(aq)}³⁺+3SO_{4(aq)}²⁻+nH₂O₍ₗ₎ (3)

There remains a need to optimize the initial extraction stage in order to increase its efficiency and reduce overall operation costs for the hydrometallurgy of rare earths. In particular, there remains a need to improve on the use of acid baking during extraction.

The above information is provided for the purpose of making known information believed by the applicant to be of possible relevance to the present invention. No admission is necessarily intended, nor should be construed, that any of the preceding information constitutes prior art against the present invention.

### SUMMARY

An object of the present application is to provide a process and system for extraction of rare earth elements using an acid soak. In accordance with an aspect of the present application, there is provided a process for extracting rare earth elements from an ore, said process comprising: (a) soaking the ore with a strong acid at a temperature of less than about 100° C. for at least 1 day; and (b) leaching the acid-soaked ore with an aqueous leaching solution to obtain a leachate comprising the rare earth elements.

In accordance with another aspect of the present application, there is provided a process for extracting rare earth elements from an ore, said process comprising: (a) soaking the ore with a strong acid and an additive comprising added water and/or metal ions, wherein the soaking is performed at a temperature of less than about 100° C. for at least 1 day; and (b) leaching the acid-soaked ore with an aqueous leaching solution to obtain a leachate comprising the rare earth elements.

### BRIEF DESCRIPTION OF TABLES AND FIGURES

For a better understanding of the application as described herein, as well as other aspects and further features thereof, reference is made to the following description which is to be used in conjunction with the accompanying drawings, where:

FIG. 1 schematically depicts a standard process for REE recovery from ore using an acid baking step;

FIG. 2 schematically depicts a process for REE recovery that includes an acid soak in H₂SO₄, with added water and additives, in accordance with one embodiment;

FIG. 3 graphically depicts the effect of soaking time on elemental recovery (%) of REE from whole ore using a process according to one embodiment, in which soaking was done at 25° C. in loosely capped glass jars with 100 g of ore and 15 g of SA and soaking times were one, two and eight weeks (baking test conditions: 100 g ore, 8.0 mL SA, 200° C., 4 hr, continuous mixing at 2.5 rpm);

FIG. 4 graphically depicts the effect of soaking temperature on elemental recovery (%) of REE from whole ore using a process according to one embodiment, in which soaking was done at 10° C. and 25° C. for 8 weeks in loosely capped glass jars with 100 g of ore and 15 g of SA (baking test conditions: 100 g ore, 8.0 mL SA, 200° C., 4 hr, continuous mixing at 2.5 rpm);

FIG. 5 graphically depicts the effect of adding 20.0 mL of water (prior to soaking) on the elemental recovery (%) of REE from whole ore using a process according to one embodiment, in which soaking was done at 25° C. for 8 weeks in loosely capped glass jars with 100 g of ore and 15 g of SA (baking test conditions: 100 g ore, 8.0 mL SA, 200° C., 4 hr, continuous mixing at 2.5 rpm);

FIG. 6 graphically depicts the effect of amount of acid used in soaking on the elemental recovery (%) of REE from whole ore using a process according to one embodiment, in which soaking was done at 25° C. for 8 weeks in loosely capped glass jars with 100 g of ore (baking test conditions: 100 g ore, 8.0 mL SA, 200° C., 4 hr, continuous mixing at 2.5 rpm);

FIG. 7 graphically depicts the effect of the duration (days) of acid soaking on metal recovery as determined for TREE, LREE, HREE and Nd recovery (%);

FIG. 8 graphically depicts the effect of the temperature (° C.) of acid soaking on metal recovery as determined for TREE, LREE, HREE and Nd recovery (%);

FIG. 9A graphically depicts the effect of ore grinding (min), prior to acid soaking for 3 weeks, on metal recovery as determined for TREE, LREE, HREE and Nd recovery (%) and FIG. 9B graphically depicts the effect of ore grinding (min), prior to acid soaking for 8 weeks, on metal recovery as determined for TREE, LREE, HREE and Nd recovery (%);

FIG. 10 graphically depicts the effect of initial water addition (mL/kg), prior to acid soaking, on metal recovery as determined for TREE, LREE, HREE and Nd recovery (%);

FIG. 11 graphically depicts the effect of additional water (mL/kg) with acid soaking of ore (4 min/100 g grinding), on metal recovery as determined for TREE, LREE, HREE and Nd recovery (%);

FIG. 12 graphically depicts the effect of agitation (bottle roll) with various amounts of water added (mL/kg) during acid soaking on metal recovery as determined for TREE, LREE, HREE and Nd recovery (%);

FIG. 13 graphically depicts the effect of varying amounts of H₂SO₄ (kg/t) during acid soaking on metal recovery as determined for TREE, LREE, HREE and Nd recovery (%);

FIG. 14 graphically depicts the effect of varying amounts of HNO₃ (mL/kg) during acid soaking on metal recovery as determined for TREE, LREE, HREE and Nd recovery (%);

FIG. 15 graphically depicts the effect of varying amounts of HCl (mL/kg) during acid soaking on metal recovery as determined for TREE, LREE, HREE and Nd recovery (%);

FIG. 16 graphically depicts the effect of varying amounts of mixed acid (H₂SO₄ and HCl, with a constant total acidity as H⁺) during acid soaking on metal recovery as determined for TREE, LREE, HREE and Nd recovery (%);

FIG. 17 graphically depicts the effect of varying amounts of mixed acid (H₂SO₄ and HNO₃, with a constant total acidity as H⁺) during acid soaking on metal recovery as determined for TREE, LREE, HREE and Nd recovery (%);

FIG. 18 graphically depicts the effect of adding varying amounts of metal ions during acid soaking on metal recovery as determined for TREE, LREE, HREE and Nd recovery (%); and

FIG. 19 graphically depicts a comparison of water leach kinetics (TREE recovery %) following a standard acid baking water leach (“baseline ABWL”) process, a long acid soak process (“baseline pit soaking”), a long acid soak with addition of water (“Enhanced pit soaking (addition of water)”) and a long acid soak with addition of water and metal ion additive (“Enhanced pit soaking (water+additive)”).

### DETAILED DESCRIPTION

### Definitions

Unless defined otherwise, all technical and scientific terms used herein have the same meaning as commonly understood by one of ordinary skill in the art to which this invention belongs.

As used in the specification and claims, the singular forms “a”, “an” and “the” include plural references unless the context clearly dictates otherwise.

The term “comprising” as used herein will be understood to mean that the list following is non-exhaustive and may or may not include any other additional suitable items, for example one or more further feature(s), component(s) and/or ingredient(s) as appropriate.

The following acronyms are used herein:
REE: Rare earth elements, which include: lanthanides, scandium and yttrium
LREE: Light rare earth elements, which include:
   Lanthanum (La)
   Cerium (Ce)
   Praseodymium (Pr)
   Neodymium (Nd)
   Promethium (Pm)
   Samarium (Sm)
   Europium (Eu) and
   Gadolinium (Gd)
   Scandium (Sc) is generally included in LREE due to his similar chemical behavior
HREE: Heavy rare earth elements, which include:
   Terbium (Tb)
   Dysprosium (Dy)
   Holmium (Ho)
   Erbium (Er)
   Thulium (Tm)
   Ytterbium (Yb)
   Lutetium (Lu)
   Yttrium (Y) is generally included in LREE due to his similar chemical behavior
TREE Total rare earth elements

The present application provides a process and system for REE extraction from ores using a long-term acid soaking step, as an alternative to acid baking, followed by a water leach. Optionally, the long-term acid soaking step is in the presence of a small amount of added water or an additive comprising metal ions. As described in more detail herein, the present application provides a process for extracting rare earth elements from an ore, comprising: soaking the ore with a strong acid at a temperature of less than about 100° C. for at least 1 day; and then subjecting the acid-soaked ore to a water leach to obtain a leachate comprising the rare earth elements. Optionally, a small amount of water is added to the acid during the acid soaking step and/or an additive comprising one or more metal ions is added to the acid during the acid soaking step to enhance the process.

The acid soaking step replaces, or at least reduces the need for baking, in order to minimize the challenges and costs associated with the acid baking operation employed in most commercial processes currently in use. If the acid soaking is to be used as a step before an acid baking, the acid may react with carbonate and release gas outside the baking reactors. At least part of this reaction happens before baking, which allows the baking process and baking equipment and leaching operational efforts to be minimized.

If the acid soaking is to be employed immediately before leaching, then the whole baking step can be omitted, which will largely reduce the capital and operational costs and also reduce the periodic down-time required for maintaining the baking facilities.

Furthermore, the long-term (i.e, one day or more) acid soak used in the process described herein allows the REE to react more with acid than is typically possible using a standard acid bake, which can benefit the metallurgical performance in the subsequent leaching step.

In the process of the present application there is no need, or a minimal need, for energy to heat the materials to typical baking temperatures (−200° C.). This, in turn, can reduce the cost of REE recovery. Furthermore, the process has lower fume/off gas emissions than the standard acid baking process.

The process of the present application also requires a smaller footprint than current commercial process involving acid baking, which makes the process more amenable to using in remote locations.

REE-Containing Ore Preparation

In the process of the present application, the REE-containing ore is prepared for use in the process using standard techniques well known in the industry. The ore can be a whole ore or an ore concentrate made by physical separation of ore components. The ore is processed appropriately to facilitate a reasonably homogeneous wetting of the surface of the ore during the subsequent acid soaking step.

Prior to use in the present extraction process, the ore is crushed to break the solid into smaller pieces, typically in the range of from about 5 to about 25 mm in diameter. Some ores require additional processing in order to maximize REE recovery, by reducing the particles size to less than about 5 mm. This can be done by standard techniques known in the industry, such as grinding or milling. In addition, in some embodiments the crushed, ground and/or milled ore is passed through an appropriate mesh to separate particles of an appropriate size. Typically, the smaller the size of the ore particles, the higher the energy used. Accordingly, to balance energy use with efficiency, the present process makes use of the largest ore rock or particle sizes possible to provide sufficient REE recovery.

A wide range of particle sizes of the ore solid feed can be used in the acid soaking step, such that the present process is not limited by any particular particle size or particle size range. However, if the size is too coarse (e.g., coarser than 6 mesh), the acid will not be able to fully penetrate the particle and will leave the REE values unreacted inside the particles. If the particle size is too fine, then the grinding cost will be higher. Further, a smaller particle size will provide much more specific surface area and will need much more acid or diluted acid to ensure the entire exposed surface are homogeneously wetted. Accordingly, selection of the appropriate particle size will be dependent, at least in part, on the circumstances of each specific application.

In certain embodiments, in which a small particle size is used, a pelletizing step can be included in preparation of the ore solid feed.

In some instances, the solid is excessively wet, for example, if the moisture content is more than 50%. In such instances, the excessive water can be removed by a solid/liquid separation or by using standard drying procedures prior to the long-term acid soak.

Long-Term Acid Soaking

In the process and system of the present application, a long-term soaking step (which can also be referred to as a curing or wetting or contacting step) is provided to allow acid to fully react with the target solid feed (e.g., ore) in advance of water/acid leaching. As is well known in the art, reaction of the acid with the ore functions to solubilize the rare earth elements in the ore to facilitate their extraction. Optionally the process includes an acid baking step between the soaking step and the leaching step. However, the soaking step of the process replaces or at least minimizes the need for acid baking. The long-term soak allows most or all of the reactions of the acid and REE present in the ore to progress in order to facilitate solubilization. Consequently, even if an acid baking step is employed, it will be much shorter and can be carried out using milder conditions than are currently used in conventional acid baking processes.

In acid baking, due to the high temperature, HCl and HNO₃ are typically not used. However, with acid soaking, various acids, such as the three acids HCl, HNO₃ and H₂SO₄, can be used individually or in combination. This can prevent formation of REE sulfate double salts, and the formation of passivating layers due to CaSO₄. By using a mixture of acids, the total cost of acid can be minimized and at the same time, the overall recovery can be enhanced since the solublization efficiency of different rare earth elements varies with each acid. Accordingly, the acid used in the soaking step is a strong acid, such as, sulfuric acid (H₂SO₄), nitric acid (HNO₃) or hydrochloric acid (HCl). In some embodiments, a mixture of two or more strong acids is used in the soaking step.

The concentration of the acid in the soaking step can range from the most concentrated forms to a concentration that is diluted with water and/or moisture from air (e.g., 28-98% H₂SO₄).

In certain embodiments the soaking step can be preceded with an addition of an amount of water, such as hot water. In other embodiments a small amount of water is added to the acid soak. In this embodiment a “small amount” of water can be 800 mL/kg of ore or less, or preferably from about 100 mL/kg to about 800 mL/kg or from about 50 mL/kg to about 800 mL/kg, or more preferably from about 100 mL/kg to about 400 mL/kg or from about 50 mL/kg to about 400 mL/kg, or even more preferably from about 100 mL/kg to about 300 mL/kg, or most preferably about 200 mL/kg.

In certain embodiments an additive or combination of additives are added to acid soaking mixture to improve the efficiency of metal recovery. The additive can be metal ions, preferably cations. Suitable metal ions include, but are not limited to, zirconium ions, aluminum ions, iron ions, potassium ions, magnesium ions, manganese ions, sodium ions, phosphorous ions, lead ions, titanium ions or zinc ions. The additive can comprise a single type of metal ions or a combination of two or more types of metal ions. In particular embodiments, the additive comprises magnesium ions, manganese ions or a mixture thereof.

In certain embodiments, the metal ions used as additives are divalent metal cations. Certain monovalent metal ions (such as, such as Na⁺, K⁺, NH⁴⁺) can form REE-cation-sulfate double salts, which are very insoluble. As a consequence, when a solution comprises these monovalent ions, leaching is impossible or at least more difficult. However, lithium ion is an exception, because Li⁺ does not form a very insoluble salt with REE and sulfate and, therefore, is suitable for use as a metal ion additive to enhance the acid soaking step of the present process.

In order to maximize the efficiency of the acid soaking step in solubilizing the REE, mixing of the acid and the solid feed should be thorough and homogeneous.

A dilute acid can be used to facilitate better mixing of the acid-solid mixture. In certain embodiments the solid:liquid ratio used in the acid soaking step ranges about 100:8 to about 100:28. The lower solid:liquid ratio is associated with a more efficient acid-solid contact. Furthermore, addition of water to the acid-solid mixture can provide a significant amount of heat to the mixture, which can be beneficial when the acid soaking is performed in a cold weather environment. Adding water in a controlled manner can allow the heat generation to be distributed throughout the soaking period. However, excessive water addition should be avoided as this can result in a reduced acidity in soaking and may be detrimental to the overall extraction efficiency.

The range of acid per kg of ore can be from quite low (for example, about 50 g of acid) to relatively high (for example, about 3 kg of acid). Selection of the optimal amount of acid is typically determined empirically based on a number of factors, including, but not limited to: particle size, REE grade and type in the ore, temperature, acid soak time, energy requirements and commercial requirements.

In certain embodiments, the acid for the acid soaking step is provided in whole or in part from a recycled waste leachate following an REE extraction process, such as the present process. The waste leachate stream can be recycled in order to move toward a zero-waste or low waste process. After recovery of REE, the remaining leachate contains acid that can be used directly, or following additional treatment, in the acid soaking step of the present recovery process. In certain embodiments, the waste leachate can also be used as a source (in whole or in part) of metal ions added to enhance the acid soaking step. For example, a waste leachate can be use used as a source of acid and/or metal ions, directly or following pre-treatment, in an acid soaking step of the present REE recovery process.

The acid-solid mixture of the acid soaking step is incubated in an acid resistant cell, pool, pile, reactor, or the like.

The acid-solid mixture is incubated above a temperature that is selected based on various parameters. If the temperature is too low, the reaction will be very slow and if the temperature is too high, it will be much more expensive to maintain the temperature. The temperature is selected to maximize metallurgy performance while minimizing energy input and operating cost. The temperature should not be below the freezing point of the acid used (e.g., keep the mixture temperature above the freezing point of 10° C. for 98% H₂SO₄) and should be below the boiling point of the acid or below a temperature that results in significant evaporation of the acid.

In certain embodiments, the temperature of the acid soak is below about 85° C., or below about 35° C., or at about 10° C. or at about 25° C. In certain embodiments, the temperature of the acid soak is selected based on ambient conditions, such that energy required for heating is minimized or avoided altogether.

In certain embodiments, the type or nature of REE extracted can be altered by selecting an appropriate temperature for the acid soak since some REEs are preferentially extracted at different temperatures.

In certain embodiments the acid-solid mixture is not stirred or mixed during the acid soak, while in other embodiments, the acid-solid mixture is continuously or intermittently stirred or mixed during the acid soak.

Additional acid can be added to the mixture during the acid soak, for example, when the mixture needs more heat, or when the acid has been rapidly consumed. In the case of a very long acid soak, it can be necessary to add more acid after a period of time, for example, to replenish acid that has evaporated or been consumed.

The total length of the soaking period is typically counted in days, weeks or months, and can be selected based on experimental study. A shorter soaking duration than ideal will result in incomplete reaction. However, when the soaking is longer than required, the overall production rate is lower because of the reduced throughput. Nonetheless, there is no upper limit to the length of the acid soak; the soak can be, several months or even years. Since the acid soak does not consume any energy after it has started, it may be beneficial to keep the mixture as long as possible to maximize the acid reactions with the REE.

In certain embodiments, the acid soaking period is for at least 2 days, or at least a week. In other embodiments, the soaking step is in the range of from about 1 week to about 12 weeks, or the soaking step is about 4 weeks or about 8 weeks long.

During incubation, the acid-solid mixture can be sealed or left open to air. If sulfuric acid is used, open air storage will result in the absorption of moisture from the air. If the acid is HCl or HNO₃, open air operation may lead to some loss of acid to the atmosphere, resulting in poor economics and deterioration of the working environment.

If the solid feed contains carbonate or bicarbonate or any other species that tend to react with acid and produce gas, sealed containers could be dangerous due to the buildup of pressure. Further, if there are fluoride-containing minerals in the ore, then hydrofluoric acid may be slowly released to the air. A well-ventilated working environment inside this storage area will be required.

Leaching

Following the acid soaking step, the solubilized rare earth elements are removed from the ore by leaching, in particular water leaching. Leaching can be performed by, for example, heap leaching, or tank or vat leaching (for example, with stirring). The aqueous leaching solution is water or an REE-barren acidic solution (for example, recycled from other operation steps).

After the long-term acid soak, the leaching step can proceed by:
optionally, adding water to the acid-solid mixture from the acid soak and allowing the mixture to cure for a period of time (e.g., from about 1 hour to about 4 or 5 weeks); and
performing a heap leaching step for a period of time (e.g., from about 1 hour to about 5 days) in which the leaching solution is passing through the acid-solid mixture from the acid soak (with or without the above curing step) at a slow flow rate to facilitate long term and slow reactions; or
performing a stirred leaching step in which the acid-solid mixture from the acid soak (with or without the above curing step) is stirred with the leaching solution in a tank or vat for a period of time (e.g., from about 1 hour to about 5 days) to facilitate fast reactions.

Leaching is performed at a temperature that facilitates or increases leaching efficiency. For example, the water leaching temperature can be an ambient temperature, standard room temperature or a raised temperature. In certain embodiments water leaching temperature is in the range of from about 0° C. to about 100° C., or from about 25° C. to about 90° C., or the leaching temperature is about 90° C. The use of lower temperatures helps to avoid the formation of hard-to-dissolve double sulfate salts, whereas the use of higher temperatures can speed up dissolution reactions.

In accordance with other embodiments, the water leaching is performed by a method that comprises washing the acid-solid mixture with water and collecting the water washes. The temperature of the water used for the water washes is in the range of from about 0° C. to about 100° C., or from about 25° C. to about 90° C., or the leaching temperature is about 90° C.

In this embodiment, each wash stage uses water or an REE-barren acidic solution (for example, recycled from other operation steps). The wash volume can vary largely and depends on the method of washing.

The extracted REE product of the leaching step can be processed according to standard techniques to purify the REE, as necessary depending on the downstream application.

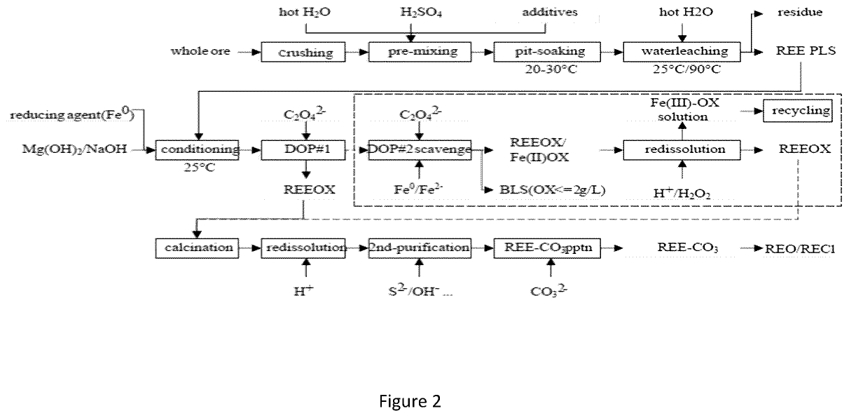

Optionally, the REE product is processed using a direct oxalate precipitation as depicted in FIG. 2. In the direct oxalate precipitation process a precipitate of REE is obtained from the acidic composition produced by the leaching step by adding a reducing agent to the acidic composition, which has a pH of 0.5 to 3 or is adjusted to a pH of 0.5 to 3 using a basic agent, and adding oxalate directly to the composition with the reducing agent. This forms an REE oxalate precipitate in the mixture, which is removed using a solid-liquid separation. The resultant REE oxalate can then be washed and further processed to marketable REE or REE salts, for example as shown in FIG. 2. This downstream process is referred to herein as a direct oxalate precipitation process since the oxalate is added directly to the acidic composition comprising a reducing agent without prior purification or precipitation steps, as required in conventional REE recovery processes.

To gain a better understanding of the invention described herein, the following examples are set forth. It should be understood that these examples are for illustrative purposes only. Therefore, they should not limit the scope of this invention in any way.

### EXAMPLES

### Example 1: Rare Earth Extraction from Whole Ore

REE are commercially extracted from ore by sulfuric acid baking at temperatures over 200° C., followed by leaching in water or dilute acid. In this Example, acid soaking was explored as an alternative to the energy-intensive acid baking process that is widely used in industry today. Soaking tests were conducted in temperature-controlled chambers using 100 g of ore in loosely capped glass jars. Soaking time, amount of acid, and temperature were varied to determine the effect of these variables on the decomposition of the ore, as observed by the percent recovery of REE in the water leach. An acid baking test was conducted as a baseline, in a rotary furnace under the following conditions: 100 g ore, 15 g sulfuric acid, 200° C., 4 hr, and 2.5 rpm. From the six soaking tests, the most significant improvement is observed during the eight week soaking test conducted at 25° C. with water added along with sulfuric acid prior to soaking. This treatment resulted in a 22.4% increase in total rare earth recovery over the baseline test, while a comparable eight week soak with no water produced a 19.8% increase in total rare earth recovery over the baseline.

Materials and Methods

Acid Soaking

The sample investigated was a whole ore. Acid soaking tests were conducted at 25° C. and 10° C., in temperature-controlled chambers (Thermo Electron Corporation, Diurnal growth chamber) using 100 g of ore. For each test, 10 g or 15 g of sulfuric acid (SA) (Fisher Chemical, A300-212, lot 171338) was added drop-wise to a glass jar containing a pre-recorded amount of ore, for accurate SA addition. The SA and ore were thoroughly mixed using a Teflon™ rod until all particles were moistened. These jars were left to soak for varying amounts of time between one to eight weeks (Table 1) with the cap loosely secured. For the sample involving water, this was added at the same point as the SA, before mixing with the ore.

TABLE 1
Acid soaking conditions

| | Amount | Soaking | Soaking | |
|---|---|---|---|---|
| | of SA | time | temperature | H₂O |
| Test ID | (g) | (w) | (° C.) | (mL) |
| ABSMW3A | 15 | 1 | 25 | — |
| ABSMW3B | 15 | 2 | 25 | — |
| ABSMW3D | 15 | 8 | 25 | — |
| ABSMW3E | 15 | 8 | 10 | — |
| ABSMW3G | 15 | 8 | 25 | 20 |
| ABSMW3H | 10 | 8 | 25 | — |

Water Leaching

Soaked samples were leached in 1.0 L of de-ionized (DI) water at 90° C. for 24 hours. This was done in 2.0 L glass vessels heated in (Glas-Col™, TM576) heating mantles equipped with Glas-Col™ Digi Trol™ II temperature controllers and Heidolph, R Z R 2021 overhead stirrers. The mantle and water were preheated in an effort to reduce the amount of time required to bring the solution up to the leaching temperature.

The jar containing a soaked sample was weighed before and after transferring the solids to a reactor and a small amount of water from the allotted 1.0 L was used to loosen, shake, and rinse all solids from the jar. Once the reactor lid was greased and secured, the overhead stirrer was lowered, and the stir rod tightened so that it hovered ˜0.5 cm above the bottom of the reactor. The solution was stirred at 500 rpm, and when the temperature reached 90° C., the time, colour, rpm and pH were recorded.

At 2, 4, 6, and 24 hours, kinetic samples were taken from the leachate. Approximately 10 mL of solution was removed from the reactor and poured into a syringe fitted with a Cole-Parmer syringe filter (NY membrane, 0.45 μm pores), then filtered into a small vial. Exactly 5.0 mL of filtered liquid was transferred via pipette to a 10.0 mL volumetric flask, and the volume was made up to the mark with 10% HNO₃. The diluted solution was sent to the Analytical Services Group (ASG) at Canmet MINING for analysis by Inductively Coupled Plasma-mass spectrometry (ICP-MS), and the remaining 5 mL from vial are returned to reactor after each sampling.

After 24 hours, the solution was filtered hot through a Whatman™ 42 filter paper (ashless, 90 mm circles), to separate solid residue from the leachate by vacuum filtration. The solid residue was washed using 200 mL of boiling deionized (DI) water, in four 50 mL additions. Solids were dried in a 60° C. oven overnight. Leachate and wash liquids were diluted by a factor of two in the same manner as the kinetic samples, prior to being submitted for chemical analysis. Each solid residue was split in half, and one half (˜50 g) was pulverized in a Retch PM 100 mini ball mill at 300 rpm for 10 minutes. This powder was split into ˜5 g portions using a rotary sample splitter, and the solid was analyzed by borate fusion followed by ICP.

Acid Baking: Baseline Test

The baking test was carried out at 200° C. using a rotary furnace (MTI Corporation, OTF-1200x) using 100 g of whole ore. The SA (8.0 mL) was added to a brass ladle containing the ore, where the two components were mixed thoroughly then transferred to the furnace, which was set to rotate at 2.5 rpm, and baked for 4 hours. The baked sample was cooled to 100° C. before leaching under the same conditions as previously described.

Calculations

The metal balance was determined using the calculated head divided by the feed, in metal units (mg), multiplied by one hundred to yield a percentage. The calculated head is the sum of metal units from the filtrate, wash, and solid residue.

The metal units for the liquids and the solid are equal to the sum of the metal units for each element analysed (i.e., La, Ce, Pr, Nd, Yb and Y). The metal units for each element are determined by taking the product of: 1) the amount of metal in the aliquot submitted for analysis (in ppm); 2) the whole volume (L) OR mass (kg) from which the aliquot was taken; and 3) the dilution factor (D.F.) of the analysed sample. For solids, D.F. is one.

In this study, the metal recovery was defined as the product divided by the calculated head (in metal units), where the product is the sum of filtrate and wash.

$$Metal balance ( \% ) = \frac{\begin{matrix}filtrate metal unit + wash metal unit + \\ solid residue metal unit\end{matrix}}{feed metal unit} \times 100$$

$$R E C ( \% ) = \frac{filtrate metal unit + wash metal unit}{\begin{matrix}filtrate metal unit + wash metal unit + \\ solid residue metal unit\end{matrix}} \times 100$$

Results and Discussion

Table 2 shows the percent elemental recovery of the six rare earth elements that were analysed in the leachate solution for each of the tests. The light rare earth elements (LREE) include lanthanum, cerium, praseodymium, and neodymium, and the heavy rare earth elements (HREE) include ytterbium and yttrium. The total rare earth element (TREE) recovery includes all six rare earths analysed.

TABLE 2
Elemental recovery (%) of REE from soaking and baking tests.

| TEST ID | La | Ce | Pr | Nd | Yb | Y | TREE | LREE | HREE |
|---|---|---|---|---|---|---|---|---|---|
| ABSMW3A | 74.38 | 69.17 | 75.37 | 73.36 | 50.92 | 56.57 | 69.46 | 71.57 | 56.12 |
| ABSMW3B | 74.43 | 68.89 | 75.55 | 73.28 | 52.21 | 58.12 | 69.58 | 71.44 | 57.65 |
| ABSMW3D | 78.26 | 80.18 | 85.07 | 80.44 | 54.86 | 61.47 | 77.28 | 80.00 | 60.93 |
| ABSMW3E | 72.66 | 73.37 | 79.46 | 73.89 | 46.79 | 53.40 | 70.57 | 73.59 | 52.87 |
| ABSMW3G | 81.28 | 82.72 | 87.58 | 82.66 | 50.76 | 57.62 | 78.96 | 82.59 | 57.07 |
| ABSMW3H | 57.23 | 59.05 | 67.29 | 60.41 | 42.46 | 48.31 | 57.51 | 59.25 | 47.84 |
| Baseline | 66.46 | 62.85 | 68.67 | 70.52 | 58.37 | 58.58 | 64.49 | 65.44 | 58.56 |
| (baking test) | | | | | | | | | |

Soaking Vs Baking, and the Effect of Soaking Time on REE Recovery

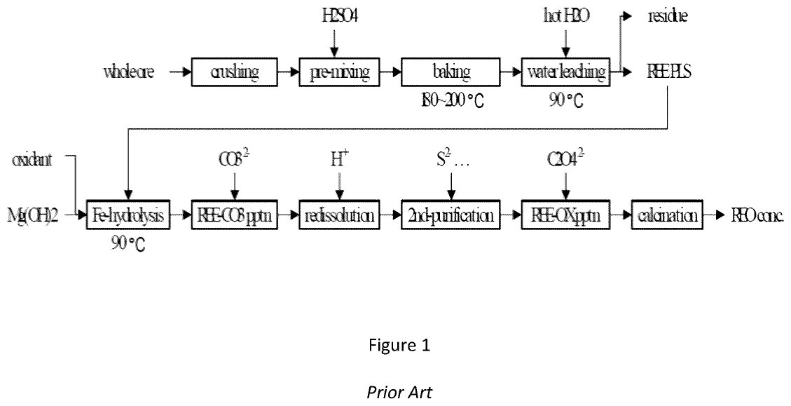

The total rare earth recovery was consistently higher in soaking tests conducted at 25° C. compared with the baseline test, which had a TREE recovery of 57.5%. The one week soaking test showed a TREE recovery of 69.5% and two weeks soaking test showed a TREE recover of 69.6% TREE; both were significantly higher that the recovery from the baseline test. An eight week soak produced the most notable improvement in REE recovery (77.2% TREE), and this soaking length was, therefore, used in subsequent tests. FIG. 1 shows the individual elemental recoveries for the baseline test and the three tests with varying soaking times.

Effect of Soaking Temperature on REE Recovery

Soaking at a lower temperature of 10° C. showed a 12.5% improvement in LREE extraction compared to the baseline test, while the recovery of the heavier elements (Y and Yb) was negatively affected by the lower temperature—HREE recovery dropped 9.7% with respect to the baseline. A breakdown of the individual elemental recoveries for these tests is shown in FIG. 2. Overall, the TREE recovery indicates that soaking at a lower temperature is more effective than baking, although not as effective as soaking at 25° C. when seeking to increase total REE recovery.

Effect of Soaking with SA and H₂O on REE Recovery

In one test, 20.0 mL of DI water was mixed in with the ore at the same point as the SA, prior to soaking for 8 weeks at 25° C. This procedure resulted in an improvement in LREE recovery over the standard eight week soaking test and a small decrease in HREE recovery, although this decrease is smaller than the one observed previously for the 10° C. soaking test. Here, the decrease was 6.3% with respect to the baseline test.

Overall, the TREE recovery for the test involving water is 78.96%, which is a significant 22.4% improvement over the baseline test. It was noted that mixing the liquid into the ore to ensure all particles were moistened was easier with the addition of water. Without wishing to be bound by theory, this may have resulted in a better distribution of the SA and improved contact between acid and ore particles, leading to an increased reaction rate.

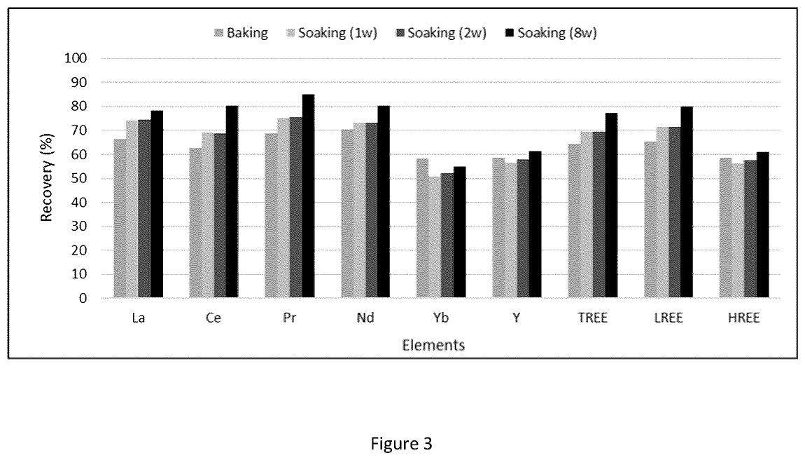

FIG. 3 shows the individual elemental recoveries for the baseline test, and the two eight week soaking tests with and without water.

Effect of the Amount of Acid Used in Soaking on REE Recovery

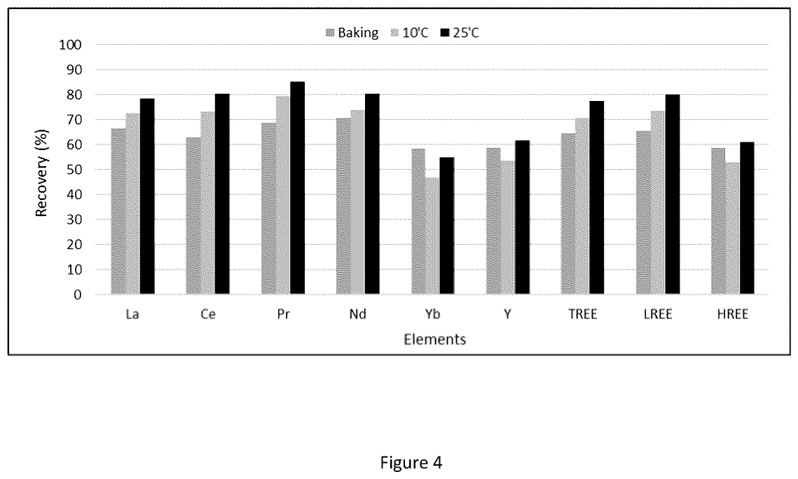

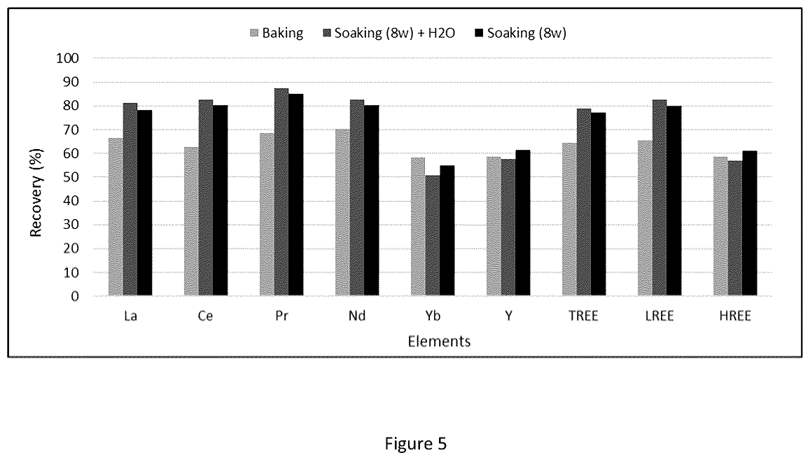

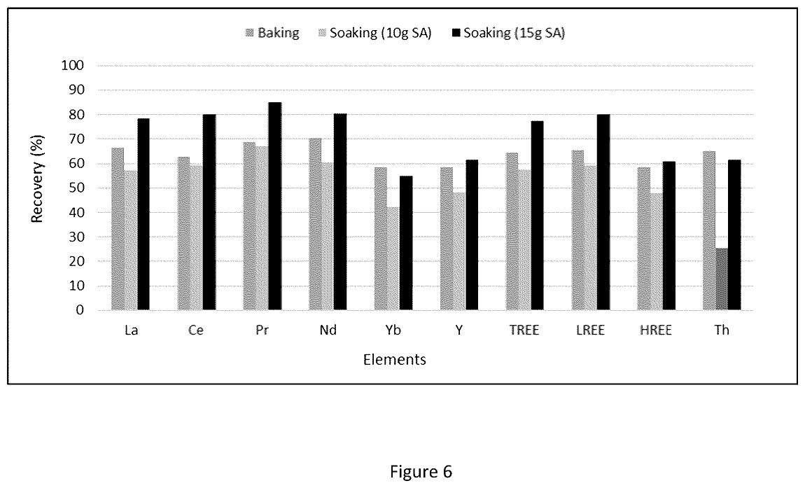

The sixth test was carried out using 10.0 g of SA instead of 15.0 g. This resulted in a decrease in recovery for all six rare earth elements analysed. Compared to the baking test, the LREE and HREE recoveries decreased by 9.5% and 18.3%, respectively. Worth noting here is the significant decrease in the amount of thorium leached into solution when less acid was used. The recovery of Th in the leach was 59% lower in the test using 10.0 g of acid, compared to the test using 15.0 g of acid. This demonstrates that treating the ore with different amounts of acid while soaking has an impact on the recovery of rare earths during leaching. The individual elemental recoveries results for these tests are shown in FIG. 4.

### Conclusions

This Example demonstrates that the use of acid soaking improves recovery of rare earth elements from ore over the recovery using acid baking. The esults indicate that increasing soaking time is beneficial, with an eight week soak (at 25° C.) showing a 19.8% increase in TREE recovery over baking. Lowering the soaking temperature to 10° C. showed a slight decrease (9.7%) in heavy rare earth recovery, however the LREE recovery showed a 12.5% improvement over baking. In areas with colder climates such as Canada's, this means soaking could be feasible over the fall and winter months with a relatively low energy cost, as less energy is required to maintain the temperature of a facility at 10° C. compared to 25° C.

The amount of acid used in soaking also had an influence on rare earth recovery. Using 10.0 g of SA instead of 15.0 g produced a 10.8% decrease in TREE recovery and a 60.8% decrease in Th recovery with respect to the baseline. This may be an advantageous trade-off for cutting acid consumption by one third.

The most significant improvement in REE recovery was seen when adding water to the ore/acid mix prior to soaking for eight weeks at 25° C. This method led to a 22.4% increase in TREE recovery compared to the baking method.

Acid soaking is an effective approach to treating ore prior to leaching rare earth elements into solution. This method presents at least three potential advantages over the acid baking method, which is currently widely used in industry. From an economic point of view this method is potentially cheaper, as minimal energy is required to maintain the leach temperature at 10-25° C. compared to the energy required to heat a furnace to over 200° C., as required in acid baking. From the engineering side, the present method removes the need for kilns and furnaces, which can cause major logistical and technical issues when the ore/acid mixture sticks to the walls and becomes difficult to mix and remove. Finally, from the environmental viewpoint this method does not produce the fumes and exhaust gases that are released during intensive acid baking, resulting in a cleaner process. This Example demonstrates that acid soaking is an effective alternative to acid baking in the extraction of rare earth elements.

### Example 2: Acid Soak and Water Leach Studies of Variables

A series of studies were performed to evaluate the effect of variables on the acid soak step. The variables studied included duration of soak, temperature of soak, grinding of ore, acid composition, water addition and addition of metal ions.

The sample used in these studies was as described below:
400 kg whole ore sample received in 2016
80% passing 6 mesh (crushing but no grinding)
NdAs the main value with other REE
Allanite as the main host mineral
Elemental analysis: Lithium Metaborate/TetraborateFusion—ICPMS or sodium peroxide fusion—ICPMS

Baseline Acid Bake Water Leach (ABWL) conditions used in this study:
6 mesh, 150 kg/t sulfuric acid, 0.5 hr preheat from 25 to 190° C.
4 hr AB 200° C. (+/5° C.), 24 hr water leach (WL) at 90° C. (+/1° C.), 9.1-10% solid
Rotary kiln rpm: 150 RPH (2.5 RPM), No pH control, no additional acid

The best ABWL result obtained in ABWL bench top tests are summarized below:
TREE 72%, LREE 74%, HREE 56%, Nd 77%
2 kg test with acid fume control measures

Baseline pit soaking (acid soak) conditions:
6 mesh, 150 kg/t sulfuric acid, 100 gram size, capped but not sealed
25° C. environmental chamber, 8 weeks, No stirring
WL at 90° C. (+/1° C.), 9.1˜10% solid. No pH control, no additional acid

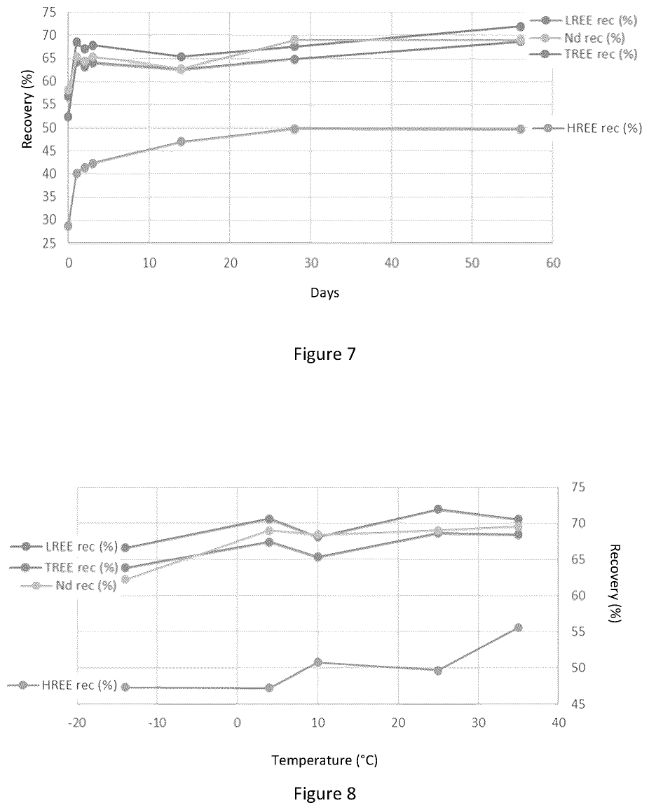

Studies were performed using essentially the same conditions as for the baseline pit soaking, but with variables altered or added as described below and as depicted in in FIGS. 7-19, which summarize the results of these studies.

As illustrated in FIG. 7, recovery of TREE, LREE, HREE and Nd increased with longer pit soaking duration. The initial increase over the first two or three days was rapid, with a gradual increase thereafter. The recovery of HREE and Nd under these conditions appeared to plateau after about 28 days.

As illustrated in FIG. 8, effective recovery of REE was possible over the full range of eight-week acid soak temperatures studied, from −15° C. to 35° C. Overall, higher recoveries obtained at temperatures over 5° C. Interestingly, HREE recovery appeared to be slightly more sensitive to temperature increase than TREE, LREE and Nd recoveries.

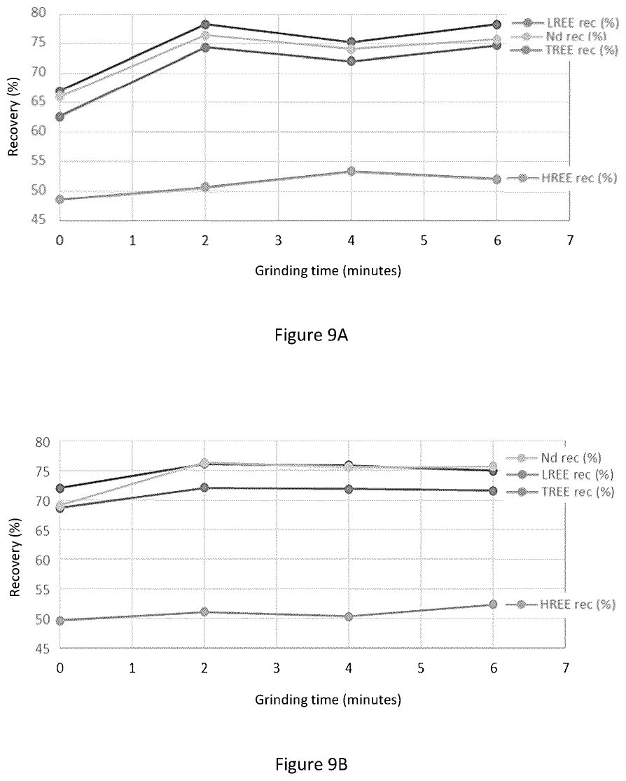

As illustrated in FIG. 9A, grinding of the ore was found to be somewhat beneficial when a three-week acid soak was performed. However, the beneficial effects of grinding were less significant with longer acid soaking times (see FIG. 9B with results using an eight-week acid soak).

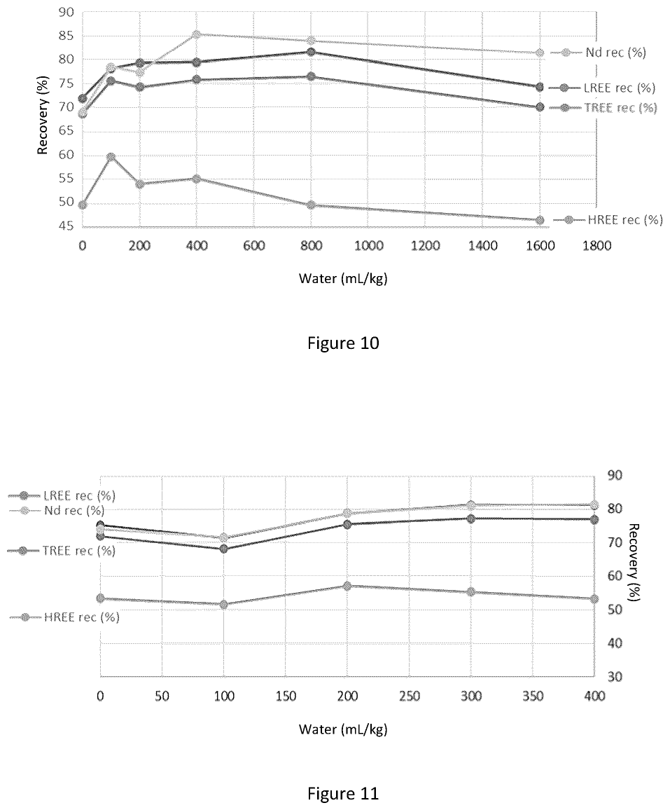

As illustrated in FIG. 10, enhanced soaking that included the addition of a small amount of water (from about 100 to about 400 mL per kg of ore) prior to acid soaking improved metal recovery. Adding water at amounts of greater than 800 mL/kg reduced recovery of TREE, LREE and Nd, while adding water at amounts of greater than 400 mL/kg reduced recovery of HREE.

As illustrated in FIG. 11, enhanced soaking that included the addition of a small amount of water (from about 100 to about 400 mL per kg of ore) generally improved metal recovery. Interestingly, this study showed that there was an improvement of HREE recovery only with addition of water up to about 200 mL/kg.

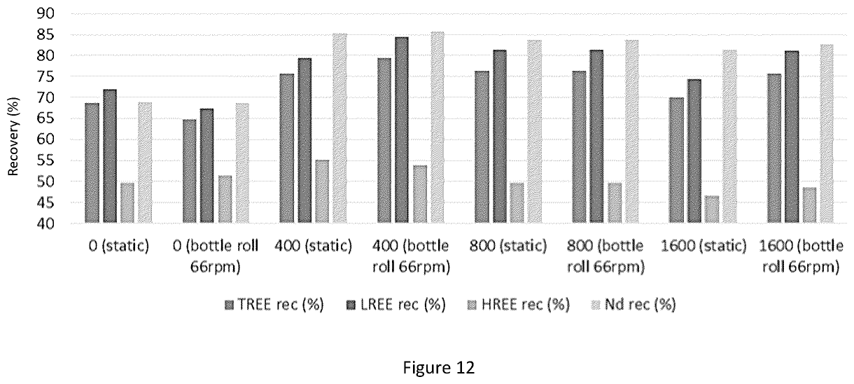

As illustrated in FIG. 12, agitation during the acid soak, with or without enhancement by addition of water, did not provide any detectable improvement or reduction in metal recovery. The studies were performed using no additional water in the acid soak or with additional water included in the acid soak in amounts of 400, 800 or 1600 mL/kg.

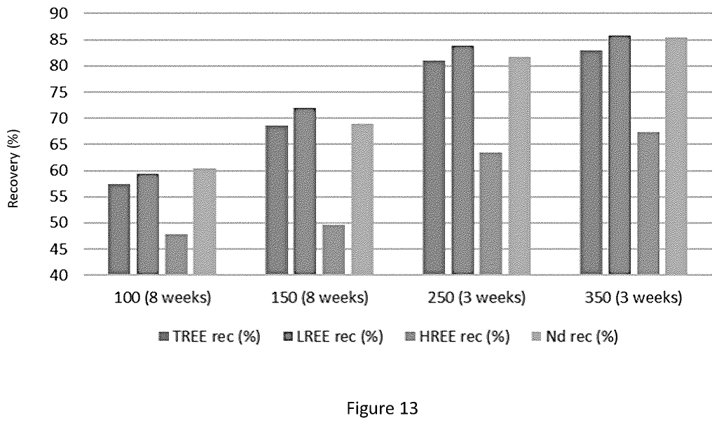

FIG. 13 illustrates the results from studies using H₂SO₄ as the strong acid during a three-week or eight-week acid soak. Varying amounts of acid were used from 100 or 150 kg per tonne of ore for an eight-week soak to 250 or 350 kg per tonne of ore for a three-week acid soak. The highest recoveries were obtained using the shorter acid soak but with higher amounts of acid. As set out above, in each case the acid soak was performed at 25° C.

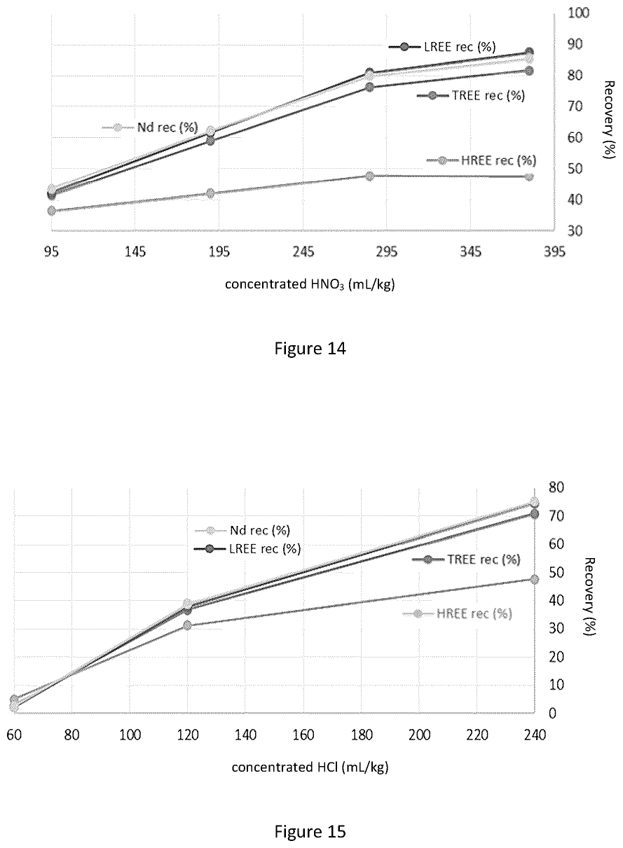

FIGS. 14 and 15 illustrate the results from using concentrated HNO₃ or HCl, respectively, as the strong acid during an eight-week acid soak at 25° C. Both strong acids were found to be effective.

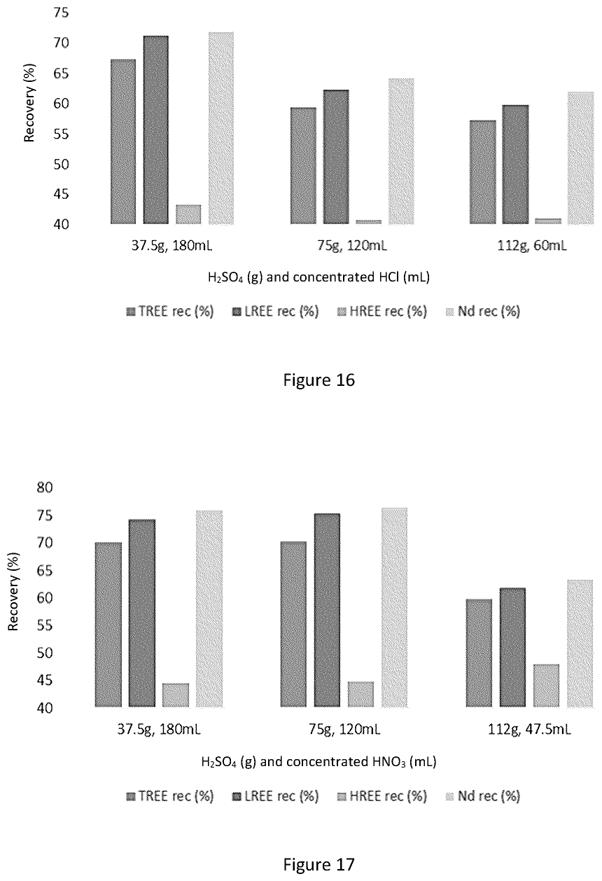

FIGS. 16 and 17 illustrate the results of using a mixed acid during the acid soak. In particular, these figures illustrate the result of using different mixtures of H₂SO₄ and HCl and H₂SO₄ and HNO₃, respectively. In each case, the total acidity, as measured by H⁺ concentration, was kept constant. The results show that the nature of the acid will affect recovery, but that use of a combination of acids can be effective.

In summary, the results shown in FIGS. 14-17 clearly demonstrated the successful use of acids other than H₂SO₄, and of acid blends, in an effective acid soak in an REE recovery process.

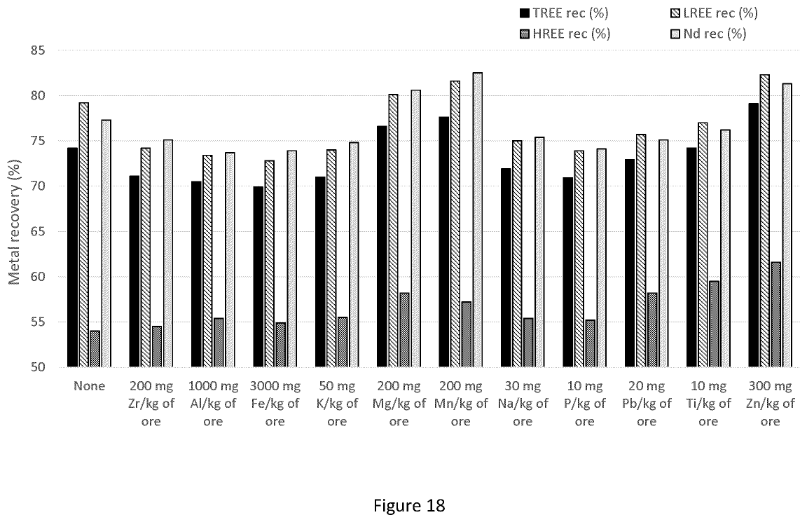

As shown in FIG. 18, comparing to the baseline soaking test (“none” addition), addition of various metal ions provided different impacts on the overall REE recovery. Among the metal ions studied, addition of divalent cations, such as Mg²⁺, Mn²⁺ and Zn²⁺, improved REE recovery.

Another very significant effect of adding metal ions was the resulting significant improvement in the leaching kinetics following acid soaking with water and the metal ions.

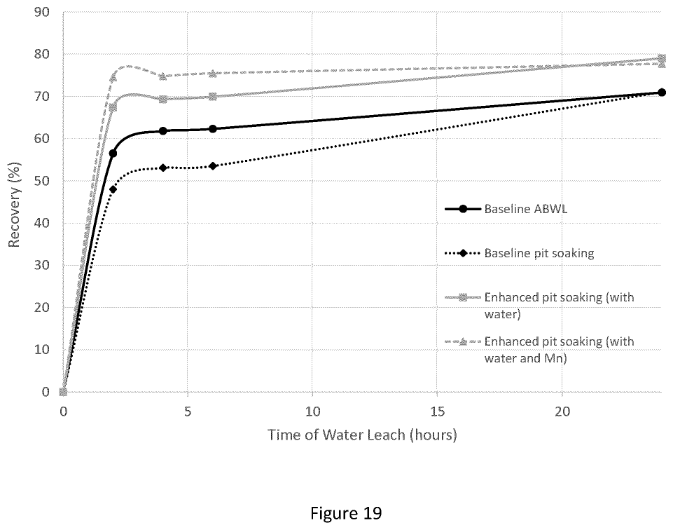

As illustrated in FIG. 19, using the same acid soaking conditions as in the baseline test (i.e., 150 kg acid/ton of ore, 25° C., 8 weeks), the addition of 200 kg water/ton of ore increased the 2 hr TREE recovery from 57% to 67%. Also, as shown in FIG. 19, when 800 mg Mn/kg of ore was added together with the water addition, the 2 hr TREE recovery was further increased to 74.5%. The higher recovery early in the water leaching step, indicated that the addition of metal ions makes the leaching process much faster. This means the overall duration of the leaching step can be reduced by a significant amount of time, thereby saving operating and capital costs.

Overall the results depicted in FIGS. 7-19 demonstrated that the long acid soak (3 weeks and 8 weeks) at room temperature (approximately 25° C.) was able to match the results achieved using the energy intensive acid baking process. Lower soaking temperatures can be used effectively, but were less effective than a room temperature soak. Enhanced soaking with the addition of a small amount of water, and/or with the addition of metal ion additives, was more efficient/effective than the acid soak without the addition of water and/or metal ion additive.

### REFERENCES

Bauer, D., Diamond, D., Li, J., Sandalow, D., Telleen, P., & Wanner, B. (2011). Critical Materials Strategy. US Department of Energy.
Demol, J., & Senanayake, G. (2018). Sulfuric acid baking and leaching of rare earth elements, thorium and phosphate from a monazite concentrate: Effect of bake temperature from 200 to 800° C. Hydrometallurgy, 179, 254-267.
Qi, D. (2018). Hydrometallurgy of rare earths: Extraction and separation. Cambridge: Elsevier.
Sadri, F., Nazari, A., & Ghahreman, A. (2017). A review on the cracking, baking and leaching processes of rare earth element concentrates. Journal of Rare Earths, 35(8), 739-752.

All publications, patents and patent applications mentioned in this Specification are indicative of the level of skill of those skilled in the art to which this invention pertains and are herein incorporated by reference to the same extent as if each individual publication, patent, or patent applications was specifically and individually indicated to be incorporated by reference.

The invention being thus described, it will be obvious that the same may be varied in many ways. Such variations are not to be regarded as a departure from the spirit and scope of the invention, and all such modifications as would be obvious to one skilled in the art are intended to be included within the scope of the following claims.

1. A process for extracting rare earth elements from an ore, said process comprising:
(a) soaking the ore with a strong acid at a temperature of less than about 100° C. for at least 1 day; and
(b) leaching the acid-soaked ore with an aqueous leaching solution to obtain a leachate comprising the rare earth elements.

2. The process of claim 1, wherein the strong acid comprises H₂SO₄, HCl, HNO₃, or any combination thereof.

3. The process of claim 1, wherein the strong acid comprises H₂SO₄.

4. The process of claim 1, wherein the soaking step is performed for a duration of at least 2 days, or at least a week.

5. The process of claim 4, wherein the duration of the soaking step is in the range of from about 1 week to about 12 weeks, or the soaking step is for about 4 weeks or for about 8 weeks.

6. The process of claim 1, wherein the ore is soaked with the strong acid at a temperature of below about 85° C., or below about 35° C.

7. The process of claim 6, wherein the ore is soaked with the strong acid at a temperature of about 10° C. or about 25° C.

8. The process of claims 1 to 7, wherein an amount of water is added to the strong acid and wherein the amount of water is about 800 mL/kg of the ore or less, or preferably from about 50 mL/kg to about 800 mL/kg, or more preferably from about 50 mL/kg to about 400 mL/kg, or even more preferably from about 100 mL/kg to about 300 mL/kg, or most preferably about 200 mL/kg.

9. The process of claim 1, wherein the acid soaking step is performed with an additive comprising metal ions.

10. The process of claim 9, where the metal ions are zirconium ions, aluminum ions, iron ions, potassium ions, magnesium ions, manganese ions, sodium ions, phosphorous ions, lead ions, titanium ions, zinc ions or any combination thereof.

11. The process of claim 10, wherein the additive comprises a single type of metal ions or a combination of two or more types of metal ions.

12. The process of claim 10, where the additive comprises magnesium ions, manganese ions or a combination thereof.

13. The process of claim 1, wherein the aqueous leaching solution is water or an REE-barren acidic solution.

14. The process of claim 1, wherein the leaching step comprises heap leaching or tank or vat leaching.
